(19) United States
(12) Patent Application Publication
(10) Pub. No.: US 2026/0162369 A1
(43) Pub. Date: Jun. 11, 2026

(54) PARAMETRIC LANDMARK DETECTION

(71) Applicant: DISNEY ENTERPRISES, INC., Burbank, CA (US)

(72) Inventors: Prashanth CHANDRAN, Zûrich (CH); Gaspard ZOSS, Zurich (CH); Derek Edward BRADLEY, Zurich (CH)

(21) Appl. No.: 18/976,025

(22) Filed: Dec. 10, 2024

(51) Int. Cl. G06T 17/20; G06T 7/73

(52) U.S. Cl. CPC G06T 17/20; G06T 7/75; G06T 2200/04; G06T 2207/20081; G06T 2207/30201

(57) ABSTRACT

One embodiment of the present invention sets forth a technique for performing landmark detection. The technique includes generating, via execution of a first machine learning model, a first set of morphable model coefficients associated with a first object depicted in a first image. The technique also includes determining one or more three-dimensional (3D) landmarks on the first object based on the first set of morphable model coefficients and projecting the first set of 3D landmarks onto the first image to generate one or more two-dimensional (2D) landmarks. The technique further includes training the first machine learning model based on one or more losses associated with the one or more 2D landmarks to generate a first trained machine learning model.

### BACKGROUND

### Field of the Various Embodiments

Embodiments of the present disclosure relate generally to machine learning and computer vision and, more specifically, to techniques for performing parametric landmark detection.

### DESCRIPTION OF THE RELATED ART

Facial landmark detection refers to the detection of a set of specific key points, or landmarks, on a face that is depicted within an image and/or video. For example, a standard landmark detection technique may predict a set of 68 sparse landmarks that are spread across the face in a specific, predefined layout. The detected landmarks can then be used in various computer vision and computer graphics applications, such as (but not limited to) three-dimensional (3D) facial reconstruction, facial tracking, face swapping, segmentation, and/or facial re-enactment.

Deep learning approaches for predicting facial landmarks can generally be categorized into main types: direct prediction methods and heatmap prediction methods. In direct prediction methods, the x and y coordinates of the various landmarks are directly predicted by processing facial images. In heatmap prediction methods, the distribution of each landmark is first predicted, and the location of each landmark is subsequently extracted by maximizing that distribution function.

However, existing landmark detection techniques are associated with a number of drawbacks. First, most landmark detectors perform a face normalization pre-processing step that crops and resizes a face in an image. This normalization is commonly performed by a separate neural network with no knowledge of the downstream landmark detection task. Consequently, normalized images outputted by this face normalization pre-processing step may exhibit temporal instability and/or other attributes that negatively impact the detection of facial landmarks in the images.

Second, facial landmarks are typically predicted during a preprocessing step for various downstream tasks, such as (but not limited to) determining a head pose, a 3D head shape, and/or blendshape parameters that can be used in facial animation, facial editing, and/or facial retargeting. Each downstream task involves additional processing related to the predicted facial landmarks, which consumes time and computational resources beyond those used to predict the facial landmarks.

As the foregoing illustrates, what is needed in the art are more effective techniques for performing landmark detection.

### SUMMARY

One embodiment of the present invention sets forth a technique for performing landmark detection. The technique includes generating, via execution of a first machine learning model, a first set of morphable model coefficients associated with a first object depicted in a first image. The technique also includes determining one or more three-dimensional (3D) landmarks on the first object based on the first set of morphable model coefficients and projecting the 3D landmark(s) onto the first image to generate a one or more two-dimensional (2D) landmarks. The technique further includes training the first machine learning model based on one or more losses associated with the 2D landmark(s) to generate a first trained machine learning model.

One technical advantage of the disclosed techniques is the ability to predict landmarks as local coefficients of a parametric morphable model. These local coefficients may then be used to perform 3D shape reconstruction, shape editing, performance retargeting, texture completion, visibility estimation, and/or other tasks, thereby reducing latency and resource overhead over prior techniques that generate 2D landmarks and perform additional processing related to the 2D landmarks during downstream tasks. These predicted attributes may additionally result in more stable 2D landmarks than conventional approaches that perform landmark detection only in 2D space. Another technical advantage of the disclosed techniques is the ability to crop an object from an image in a manner that is optimized for a subsequent landmark detection task. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and execution engine of FIG. 1, according to various embodiments.

FIG. 3A illustrates how the landmark prediction model of FIG. 2 generates landmarks for a face depicted in an image, according to various embodiments.

FIG. 3B illustrates how the localization model of FIG. 2 generates body landmarks that are used to produce a cropped image depicting a face, according to various embodiments.

FIG. 4 illustrates an example set of training images associated with the machine learning models of FIG. 2, according to various embodiments.

FIG. 5 is a flow diagram of method steps for performing landmark detection, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

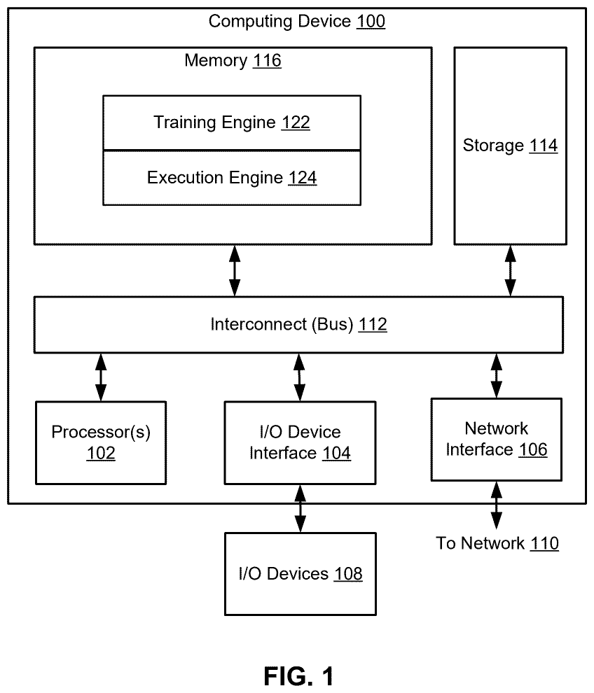

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications. In a third example, training engine 122 and execution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In one or more embodiments, training engine 122 and execution engine 124 use a set of machine learning models to perform and/or improve various tasks related to landmark detection. These tasks include a localization preprocessing step, in which body landmarks are used to localize and generate a crop of a region within an image that depicts a face (or another type of deformable object that is included in a body). These tasks may also, or instead, include predicting coefficients of a morphable model associated with the face (or other type of deformable object) while using two-dimensional (2D) landmarks as supervision. Training engine 122 and execution engine 124 are described in further detail below.

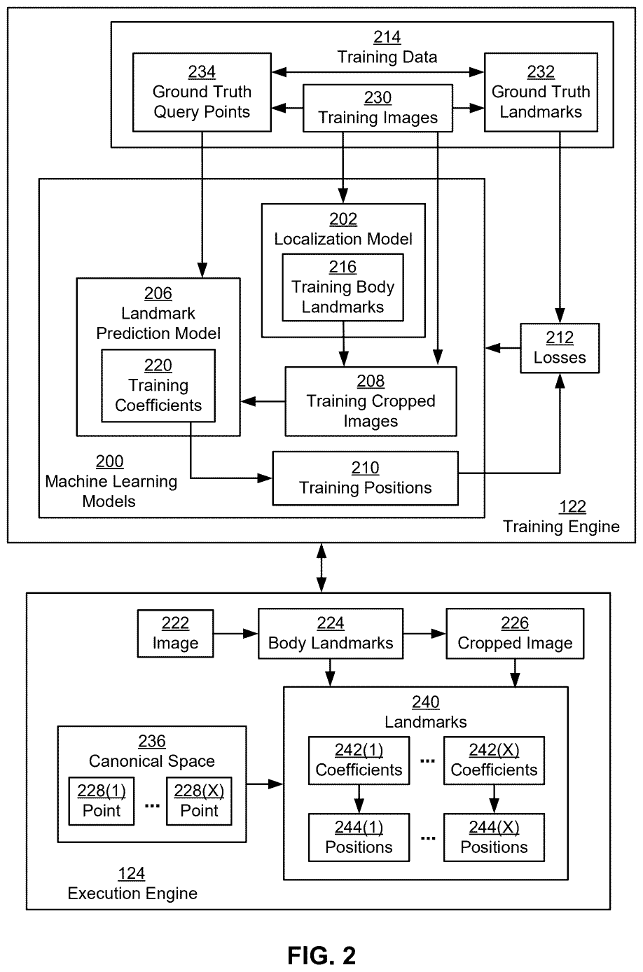

FIG. 2 is a more detailed illustration of training engine 122 and execution engine 124 of FIG. 1, according to various embodiments. As mentioned above, training engine 122 and execution engine 124 operate to train and execute a set of machine learning models 200 on a landmark detection task, in which a set of landmarks 240 is detected as a set of key points on a face (or another type of body part and/or deformable object) depicted within an image 222.

In some embodiments, a landmark includes a distinguishing characteristic or point of interest in a given image (e.g., image 222). Examples of facial landmarks 240 include (but are not limited to) the inner or outer corners of the eyes, the inner or outer corners of the mouth, the inner or outer corners of the eyebrows, the tip of the nose, the tips of the ears, the location of the nostrils, the tip of the chin, a facial feature (e.g., a mole, birthmark, etc.), and/or the corners or tips of other facial marks or points. Any number of landmarks 240 can be determined for individual facial regions such as (but not limited to) the eyebrows, right and left centers of the eyes, nose, mouth, ears, and/or chin.

Additionally, landmarks 240 may be defined for other types of body parts and/or objects. For example, landmarks 240 may correspond to parts of the eyes, teeth, jaw, limbs, hands, feet, head, torso, full body, and/or another part of a human, animal, robot, and/or another type of deformable object.

Further, machine learning models 200 may include functionality to detect multiple sets and/or types of landmarks. More specifically, one or more machine learning models 200 may detect a set of body landmarks 224 corresponding to points on a body of a human, animal, robot, and/or another entity. One or more machine learning models 200 may also use information associated with body landmarks 224 to detect a set of landmarks 240 corresponding to points on a face, head, limb, torso, and/or another part of the entity, as described in further detail below.

As shown in FIG. 2, machine learning models 200 include a localization model 202 and a landmark prediction model 206. Landmark prediction model 206 includes various neural networks and/or other machine learning components that are used to predict landmarks 240 on a face (and/or another type of body part and/or object) depicted in image 222.

In one or more embodiments, landmarks 240 are generated for an arbitrary set of points 228(1)-228(X) (each of which is referred to individually herein as point 228) that are defined within a canonical space 236. For example, canonical space 236 may include a fixed template surface for a face (and/or another type of object) that is parameterized into a 2D UV space. Each point 228 may be defined (e.g., via user input, a configuration file, etc.) as a 2D UV coordinate that corresponds to a specific position on the template surface and/or as a 3D coordinate in canonical space 236 around the template surface.

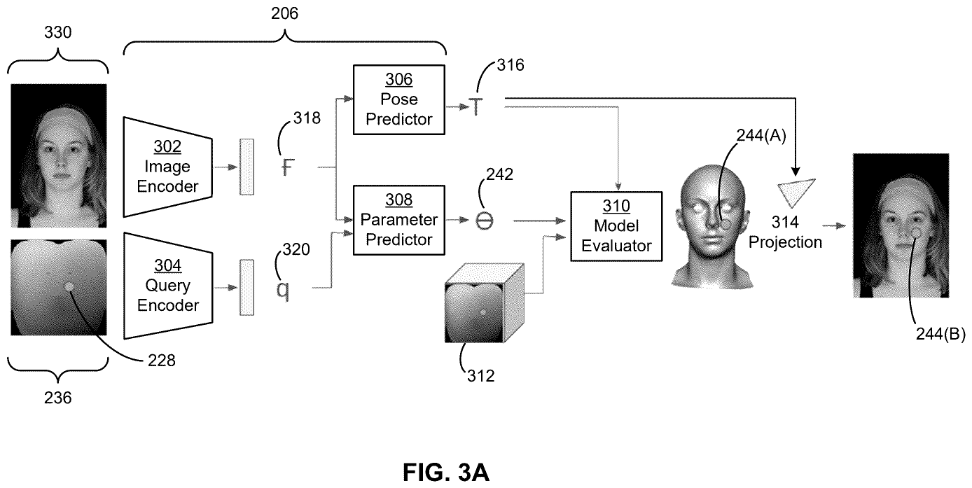

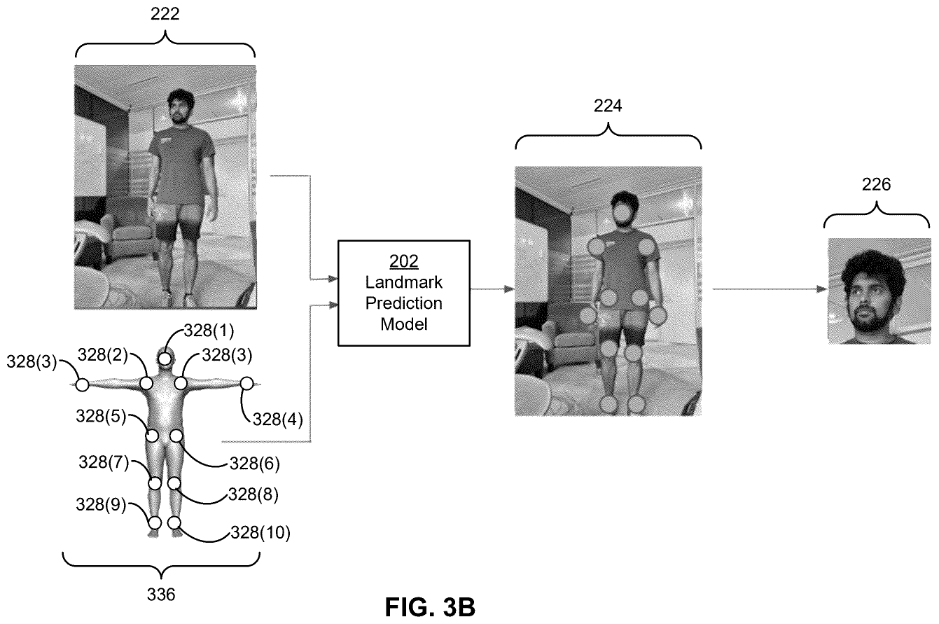

More specifically, landmark prediction model 206 generates landmarks 240 as multiple sets of coefficients 242(1)-242(X) (each of which is referred to individually herein as coefficients 242) associated with a three-dimensional (3D) morphable model (3DMM), parametric face model, multilinear model, blendshape model, and/or another type of parametric morphable model of a face (or another type of object). These sets of coefficients 242 may be converted into corresponding sets of positions 244(1)-244(X) (each of which is referred to individually herein as positions 244) in a 2D and/or 3D space associated with image 222. For example, landmark prediction model 206 may generate a different set of coefficients 242 for each point 228 specified in canonical space 236. The parametric morphable model may be evaluated using these coefficients 242 to determine a 3D position of that point 228 in canonical space 236. The 3D position may then be projected through a canonical camera associated with canonical space 236 to produce a corresponding 2D position in a “screen space” associated with image 222, as described in further detail below with respect to FIG. 3A.

FIG. 3A illustrates how landmark prediction model 206 of FIG. 2 generates landmarks for a face depicted in an image, according to various embodiments. More specifically, FIG. 3A illustrates the use of landmark prediction model 206 in generating landmarks 240 that include a set of coefficients 242, a 3D position 244(A), and a 2D position 244(B) for a point 228 on a face depicted in an image 330, according to various embodiments of the present disclosure.

As shown in FIG. 3A, input into landmark prediction model 206 includes image 330 and a given point 228 that is defined using coordinates in the parametric UV canonical space 236. Within landmark prediction model 206, an image encoder 302 generates a set of features 318 F from the inputted image 330. For example, image encoder 302 may include a convolutional encoder, a deep neural network (DNN), and/or another type of machine learning model that converts image 330 into features 318 in the form of a d-dimensional feature descriptor.

A pose predictor 306 in landmark prediction model 206 predicts, from features 318, parameters 316 T that characterize the pose of a head (or another object) in image 330. For example, pose predictor 306 may include a neural network and/or another type of machine learning model that predicts parameters 316 as a head pose parameterized as a nine-dimensional (9D) vector, where the 9D vector includes a six-dimensional (6D) rotation and a 3D translation. In general, parameters 316 can represent any rigid transformation of the object depicted in image 330.

Pose predictor 306 may also, or instead, predict parameters 316 that include camera intrinsics specifying a focal length in millimeters (mm) under an ideal pinhole assumption. To bias the training of landmark prediction model 206 towards plausible focal lengths, the predicted focal length may include a displacement that is added to a predefined focal length (e.g., 60 mm).

Within landmark prediction model 206, a query encoder 304 converts point 228 into a position encoding 320 q. For example, query encoder 304 may include an MLP and/or another type of machine learning model that generates a vector-based position encoding 320 q∈ [symbol] j^{B} from a 2D and/or 3D position of point 228 in canonical space 236.

Landmark prediction model 206 also includes a parameter predictor 308 that uses features 318 from image encoder 302 and position encodings 320 from query encoder 304 to generate coefficients 242 associated with point 228. For example, parameter predictor 308 may include a feedforward neural network and/or another type of machine learning model that converts features 318 and position encodings 320 into coefficients 242. These coefficients 242 and parameters 316 from pose predictor 306 are used by a model evaluator 310 for a parametric morphable model 312 to determine a landmark that includes a 3D position 244(A) of point 228 in canonical space 236. For example, model evaluator 310 may generate, for a given set of coefficients 242 and parameters 316, a 3D offset that is added to the original position of point 228 in canonical space 236 to produce a corresponding 3D position 244(A) of point 228 on the face depicted in image 330. Model evaluator 310 may also, or instead, use morphable model 312 to convert coefficients 242 and parameters 316 directly into a 3D position for point 228. Model evaluator 310 may further apply a transformation corresponding to a head pose and/or other parameters 316 predicted by pose predictor 306 to produce a pose-specific 3D position 244(A) of point 228. A projection 314 of the pose-specific 3D position 244(A) is then performed using a canonical camera (e.g., with a focal length and/or focal length displacement as predicted by pose predictor 306) to generate a corresponding 2D position 244(B) in the screen space of image 330.

In one or more embodiments, morphable model 312 is implemented using a transformer neural network (or another type of machine learning model) that represents a domain of deformable shapes such as faces, hands, and/or bodies. A canonical shape that is defined using canonical space 236 is used as a template from which various positions can be sampled or defined, and each shape in the domain is represented as a set of offsets from a corresponding set of positions on the canonical shape. The transformer neural network includes an encoder that converts a first set of positions in the canonical shape and a corresponding set of offsets for a target shape into a shape code that represents the target shape. The transformer neural network also includes a decoder that generates an output shape, given the shape code and a second set of positions in the canonical shape. In particular, the decoder network generates a new set of offsets based on tokens that represent the second set of positions 244 and that have been modulated with the shape code. The new set of offsets is then combined with the second set of positions inputted into the decoder to produce a set of 3D positions 244 in the output shape.

Coefficients 242 associated with the transformer neural network may correspond to different subsets of the shape code. These subsets of the shape code may include an “identity” code representing an identity of a subject (e.g., a specific person) and an “expression” code representing an expression (e.g., a specific facial expression). During training, the identity code is constrained to be the same for all expressions of the same subject, while the expression code is varied for each individual expression. The identity and expression codes can additionally be modulated separately to produce new output shapes and/or variations on output shapes outputted by the decoder. For example, the identity associated with the 3D positions 244 may be varied by changing (e.g., randomly sampling, interpolating, etc.) the identity code and fixing the expression code. Conversely, the expression associated with the 3D positions may be varied by changing (e.g., randomly sampling, interpolating, etc.) the expression code and fixing the identity code. Different identity and/or expression codes can also be applied to different regions of canonical space 236. For example, different identity and/or expression codes can be used with different points 228 in canonical space 236 to generate corresponding 3D positions 244 that reflect a combination of the corresponding identities and/or expressions.

Morphable model 312 also, or instead, includes an anatomical implicit model that learns a set of anatomical constraints associated with a face, body, hand, and/or another type of deformable shape, given a set of 3D geometries of the shape. For example, the anatomical implicit model may include one or more neural networks that are trained to predict, for a given point 228 on a “baseline” shape (e.g., a face with a neutral expression), a bone point, a bone normal, a soft tissue thickness, and/or other attributes associated with the anatomy of the object. Coefficients 242 inputted into the anatomical implicit model may include skinning weights, corrective displacements, blending coefficients, and/or other attributes that reflect a deformation of the baseline shape (e.g., a facial expression and/or blendshape). These coefficients 242 may be used to displace that point 228 to a new 3D position 244(A) corresponding to the deformation.

While morphable model 312 has been described above with respect to specific implementations and/or types of models, it will be appreciated that morphable model 312 can include other types of parametric shape models. For example, morphable model 312 may include and/or be implemented using a 3DMM, multilinear model, blendshape model, variational autoencoder (VAE), active appearance model, principal components analysis (PCA) model, local deformation model, and/or another type of model that outputs a shape and/or positions 244 on the shape based on inputted coefficients 242. In another example, morphable model 312 may convert a given set of coefficients 242 into multiple points 228 and/or positions 244 on the face (or another type of object). In a third example, multiple parameter predictors may be used to generate, for a given point 228, multiple sets of coefficients 242 associated with multiple morphable models of a face (or another type of object). These sets of coefficients 242 may be evaluated using the corresponding morphable models to generate multiple corresponding positions 244 for the point, which can then be averaged (or otherwise aggregated) into a final position 244 for the point.

Additionally, morphable model 312 may be learned and/or updated with landmark prediction model 206. For example, morphable model 312 may include a neural network and/or another type of machine learning model that is trained in an end-to-end fashion with landmark prediction model 206 on a landmark prediction task.

Returning to the discussion of FIG. 2, in some embodiments, localization model 202 includes various neural networks and/or other machine learning components that are used to predict body landmarks 224 for a human (or another type of object) depicted in image 222. These body landmarks 224 are used to localize a region in image 222 that depicts a face (or another type of object for which landmarks 240 are to be generated). The localized region is used to generate a cropped image 226 that includes the face and excludes extraneous information that is not relevant to the detection of landmarks 240 on the face. This cropped image 226 can then be used as input into landmark prediction model 206, in lieu of or in addition to the original uncropped image 222.

FIG. 3B illustrates how localization model 202 of FIG. 2 generates body landmarks 224 that are used to produce a cropped image 226 depicting a face, according to various embodiments. As shown in FIG. 3B, an uncropped image 222 and a set of points 328(1)-328(10) (each of which is referred to individually herein as point 328) in a canonical space 336 are inputted into localization model 202. Image 222 may include a face as a body part within a larger human body. Canonical space 336 may may include a fixed template body surface that is parameterized into a 2D UV space. Each point 328 may be defined as a 2D UV coordinate that corresponds to a specific position on the template body surface and/or as a 3D coordinate in canonical space 236 around the template body surface.

Given this input, localization model 202 outputs a set of body landmarks 224 corresponding to 2D positions of points 328 on the body depicted in image 222. For example, localization model 202 may include a convolutional encoder and/or another type of machine learning model that converts image 222 into a set of features. Localization model 202 may also include a position encoder that is implemented using an MLP (or another type of machine learning model) and converts points 328 in canonical space 336 into corresponding position encodings. Localization model 202 may further include a landmark predictor that is implemented using an MLP (or another type of machine learning model) and generates, for a given position encoding, a body landmark that includes a 2D position of a corresponding point 328 within image 222. As shown in FIG. 3B, body landmarks 224 correspond to 2D positions of a face, left shoulder, right shoulder, left hand, right hand, left hip, right hip, left knee, right knee, left foot, and right foot of a body depicted within image 222.

Body landmarks 224 are used to extract cropped image 226 as a region within image 222. For example, one or more body landmarks 224 that correspond to the face may be used to compute a bounding box for the face within image 222. Cropped image 226 may be generated by sampling pixels that fall within the bounding box from image 222. Cropped image 226 may then be inputted into landmark prediction model 206 and used to determine coefficients 242 and/or positions 244 of points 228 in canonical space 236 associated with the face, as discussed above.

Returning to the discussion of FIG. 2, training engine 122 trains localization model 202 and/or landmark prediction model 206 using training data 214 that includes training images 230, ground truth landmarks 232 associated with training images 230, and ground truth query points 234 that are defined with respect to canonical space 236. Training images 230 include images of objects that are captured under various conditions. For example, training images 230 may include real and/or synthetic images of a variety of faces in different poses and/or facial expressions, at different scales, in various environments (e.g., indoors, outdoors, against different backgrounds, etc.), under various conditions (e.g., studio, “in the wild,” low light, natural light, artificial light, etc.), and/or using various cameras.

Ground truth landmarks 232 include 2D positions in training images 230 that correspond to ground truth query points 234 in the 3D canonical space 236. For example, ground truth landmarks 232 may include 2D pixel coordinates in training images 230, 2D coordinates in a 2D space that is defined with respect to some or all training images 230, and/or another representation. Ground truth query points 234 may include 2D UV coordinates on the surface of the template shape defined in canonical space 236, 3D coordinates in canonical space 236, and/or another representation. Each ground truth landmark may be associated with a corresponding training image and a corresponding ground truth query point within training data 214.

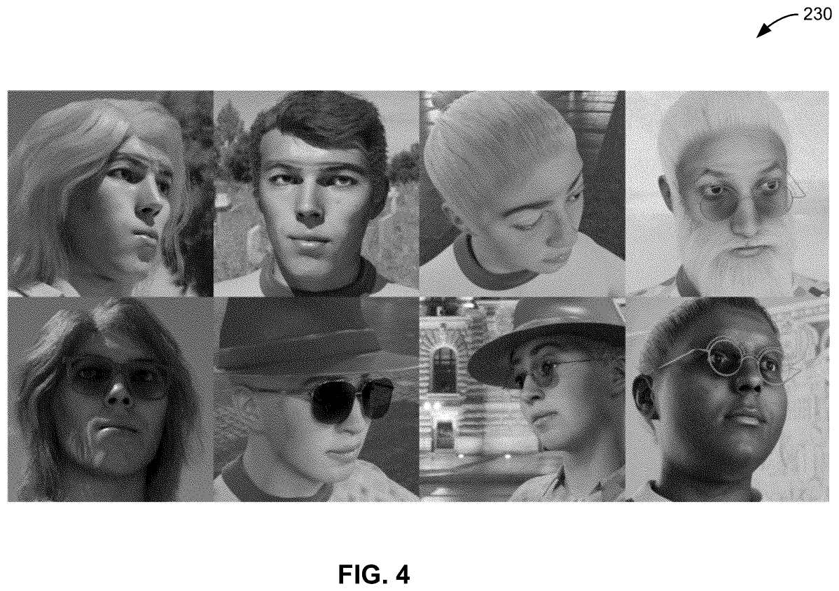

In one or more embodiments, training images 230 include one or more synthetic images that are generated using a mix of captured real data and artist-created assets. These synthetic images can be used to supplement a dataset of training images 230 that are captured in a controlled studio setting with corresponding dense ground truth query points 234 and ground truth landmarks 232. Generation of synthetic training images 230 using captured real data and artist-created assets is described in further detail below with respect to FIG. 4.

FIG. 4 illustrates an example set of training images 230 associated with machine learning models 200 of FIG. 2, according to various embodiments. More specifically, FIG. 4 illustrates example synthetic training images 230 that are generated using a mix of captured real data and artist-created assets.

As shown in FIG. 4, the synthetic training images 230 include depictions of different faces, skin textures, hair, accessories, lighting conditions, backgrounds, and camera angles. These synthetic training images 230 may be generated by combining reconstructed facial geometry and skin textures for the facial skin region from a database of faces captured in a controlled studio setting with artist-created assets for facial and scalp hair, accessories (e.g., glasses, hats, etc.), and/or clothing. These synthetic training images 230 may also, or instead, include new geometries of facial identities and expressions that are generated using one or more morphable models described above. The facial hair and/or scalp hair may be parametrically controlled and/or chosen from a set of artist-created styles. For additional variability, non-skin assets may be textured with a parametrically controlled shader, camera angles may be sampled from 360 degrees to cover viewpoints from behind the head, and/or the synthetic training images 230 may be rendered using backgrounds that are sampled from a large set of environment maps.

Returning to the discussion of FIG. 2, training engine 122 inputs captured and/or synthetic training images 230 into localization model 202. For each inputted training image, localization model 202 generates a set of training body landmarks 216 that specify 2D positions of various body parts within the training image. Training engine 122 uses training body landmarks 216 and training images 230 to generate corresponding training cropped images 208 from regions within training images 230 that include a subset of training body landmarks 216 corresponding to faces (or other objects for which additional landmarks are to be generated).

Training engine 122 inputs ground truth query points 234 and training cropped images 208 into landmark prediction model 206. Based on this input, landmark prediction model 206 generates training coefficients 220 that are evaluated with respect to a morphable model (e.g., morphable model 312 of FIG. 3A) to generate 3D training positions 210 of ground truth query points 234 in canonical space 236.

Training engine 122 uses camera parameters outputted by landmark prediction model 206 for each training image and/or camera parameters associated with a canonical camera to convert the 3D training positions 210 for ground truth query points 234 into a 2D training positions 210 in a 2D space associated with the training image. Training engine 122 computes one or more losses 212 between the 2D training positions 210 and the corresponding ground truth landmarks 232. For example, training engine 122 may compute losses 212 as a Gaussian negative log likelihood loss, mean squared error, and/or another measure of difference between the 2D training positions 210 and ground truth landmarks 232. Training engine 122 additionally uses a training technique (e.g., gradient descent and backpropagation) to iteratively update parameters of localization model 202 and/or landmark prediction model 206 in a way that reduces losses 212.

In some embodiments, localization model 202 is trained in an end-to-end fashion along with landmark prediction model 206. Because the output of localization model 202 is unsupervised, localization model 202 may learn to generate training body landmarks 216 that minimize losses 212 computed between 2D training positions 210 and the corresponding ground truth landmarks 232.

Localization model 202 may also, or instead, be trained separately from landmark prediction model 206. For example, localization model 202 may be pretrained on a body landmark detection task using a set of images (e.g., training images 230 and/or another set of images) and ground truth body landmarks for bodies depicted in the training images. After pretraining of localization model 202 is complete, localization model 202 may be retrained in an end-to-end fashion with landmark prediction model 206 to allow localization model 202 to generate training body landmarks 216 that optimize for the detection of landmarks 240 on faces and/or other body parts of bodies depicted in training images 230.

After training of localization model 202 and/or landmark prediction model 206 is complete, execution engine 124 executes the trained localization model 202 and/or landmark prediction model 206 to detect additional landmarks 240 on a new image 222. More specifically, execution engine 124 uses localization model 202 to generate body landmarks 224 for a body depicted in image 222. Execution engine 124 also uses body landmarks 224 to convert image 222 into a corresponding cropped image 226 that includes a subset of image 222 that depicts a face and/or another body part for which landmarks 240 are to be generated.

Execution engine 124 obtains a set of points 228 in canonical space 236 for which landmarks 240 are to be generated. Execution engine 124 inputs points 228 and cropped image 226 into landmark prediction model 206. Execution engine 124 executes landmark prediction model 206 to generate, for each point 228, a set of coefficients 242 that can be used with a morphable model. Execution engine 124 evaluates the morphable model using coefficients 242 to determine 3D positions 244 as offsets from the corresponding points 228 in canonical space 236 and/or updated positions of the corresponding points 228 in canonical space 236. Execution engine 124 uses additional camera parameters predicted by landmark prediction model 206 and/or associated with a canonical camera to project the 3D positions 244 onto 2D positions 244 in a 2D space associated with cropped image 226. Execution engine 124 may also use pixel mappings between cropped image 226 and image 222 to convert 2D positions 244 in the 2D space associated with cropped image 226 into 2D positions 244 in the 2D space associated with image 222.

In some embodiments, execution engine 124 uses coefficients 242, positions 244, and/or other output associated with machine learning models 200 to perform various downstream tasks associated with facial landmark detection. First, execution engine 124 may use coefficients 242 and/or positions 244 to perform reconstruction and/or editing of a face (or another type of object). For example, execution engine 124 may densely query every point 228 in canonical space 236 and use the resulting coefficients 242 and/or 3D positions 244 to form a full face mesh that matches the face depicted in image 222 and/or cropped image 226. Execution engine 124 may also, or instead, edit the face mesh by adjusting one or more sets of coefficients 242 and/or 3D positions 244.

Execution engine 124 may also, or instead, perform performance retargeting using coefficients 242. For example, execution engine 124 may use landmark prediction model 206 to determine, for a given point 228 and/or set of points 228 in canonical space 236 and a set of images (e.g., a video of a facial and/or another type of performance), a corresponding set of identity, expression, and/or blendweight coefficients 242 of a local multilinear model. Execution engine 124 may use some or all coefficients 242 to “transfer” the identity, expression, and/or other attributes of the face (or another type of object) depicted in the images to a different face (or object).

Execution engine 124 may also, or instead, generate textures associated with an object depicted in one or more images. For example, a set of 3D positions 244 may be predicted for each skin point on the template face surface in canonical space 236 and each view of a face. The pixel colors from image 222 and/or cropped image 226 for a given view may then be reprojected onto a posed mesh that is created using 3D positions 244 and shares the same triangles as a template surface in canonical space 236. The reprojected pixel colors for each view may then be unwrapped into a texture using the UV parameterization of the template surface in canonical space 236. View-specific textures may then be averaged across the views to generate a single combined texture.

Execution engine 124 may also, or instead, estimate the visibility of 2D landmarks using the corresponding 3D positions 244. For example, execution engine 124 may generate a 3D mesh using 3D positions 244. Execution engine 124 may determine if the landmark associated with each 3D position is visible based on the angle between the normal vector of the mesh at the landmark and the direction of the camera, the depth of each 3D position relative to the camera, and/or other techniques.

Execution engine 124 may also, or instead, perform facial segmentation using 2D and/or 3D positions 244 of landmarks 240. For example, execution engine 124 may segment image 222 and/or cropped image 226 into regions representing different parts of the face (e.g., nose, lips, eyes, cheeks, forehead, patches of skin, arbitrarily defined regions, etc.). Each region may be associated with a subset of points 228 in canonical space 236. These points may be converted into 2D positions 244 in cropped image 226 and/or image 222 and/or 3D positions 244 associated with canonical space 236. The predicted 2D positions 244 may identify a set of pixels within a corresponding image that correspond to the region, and the predicted 3D positions 244 may identify a portion of a face mesh that corresponds to the region.

Execution engine 124 may also, or instead, perform landmark tracking. For example, a user may define a set of points (e.g., moles, blemishes, facial features, pores, etc.) to be tracked on a face depicted within an image. Execution engine 124 may use machine learning models 200 to optimize for corresponding points 228 in canonical space 236. Execution engine 124 may then use the same points 228 to generate coefficients 242, 2D positions 244, and/or 3D positions 244 corresponding to the specified points 228 over a series of video frames and/or one or more additional images of the same face. The generated coefficients 242, 2D positions 244, and/or 3D positions 244 may then be used to touch-up, “paint,” and/or otherwise edit the corresponding locations within the video frames, image(s), and/or meshes.

While the operation of training engine 122 and execution engine 124 has been described with respect to a set of machine learning models 200 that include localization model 202 and landmark prediction model 206, it will be appreciated that localization model 202 and/or landmark prediction model 206 may be combined in other ways and/or used independently of one another. For example, localization model 202 may be used to generate cropped images for a variety of 2D and/or 3D landmark detectors. In another example, landmark prediction model 206 may be used to generate coefficients 242 and/or positions 244 with or without preprocessing performed by localization model 202.

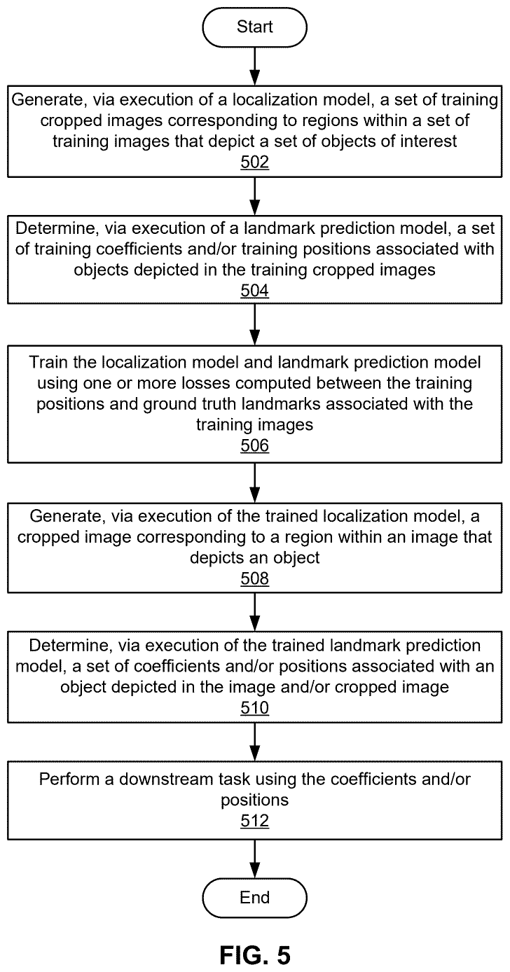

FIG. 5 is a flow diagram of method steps for performing landmark detection, according to various embodiments. Although the method steps are described in conjunction with FIGS. 1-2, persons skilled in the art will understand that any system configured to perform the method steps, in any order, falls within the scope of the present disclosure.

As shown, in step 502, training engine 122 generates, via execution of a localization model, a set of training cropped images corresponding to regions within a set of training images that depict a set of objects of interest. For example, training engine 122 may input each training image into the localization model and use the localization model to generate a set of body landmarks associated with a body depicted in the training image. Training engine 122 may use a subset of the body landmarks corresponding to a face (or another type of object) to identify a region within the training image that includes the face. Training engine 122 may then generate a bounding box for the region and use the bounding box to generate the cropped image as a crop of the region from the training image.

In step 504, training engine 122 determines, via execution of a landmark prediction model, a set of training coefficients and/or training positions associated with objects depicted in the training cropped images. For example, training engine 122 may input each training cropped image into the landmark prediction model. Training engine 122 may use an image encoder in the landmark prediction model to generate a set of features representing each training cropped image. Training engine 122 may also use a pose predictor in the landmark prediction model to generate a set of parameters associated with a pose of an object and/or a virtual and/or real camera used to capture the object in the training cropped image. Training engine 122 may input the features (and optional position-encoded points in a canonical space associated with the object) into a parameter predictor in the landmark prediction model and use the parameter predictor to generate multiple sets of coefficients for multiple points on the object. Training engine 122 may evaluate a morphable model using the sets of coefficients and predicted pose to generate a set of 3D training positions for the object. Training engine may additionally use camera parameters predicted by the pose predictor and/or associated with a canonical camera to project the 3D training positions onto the training cropped images, thereby generating a set of 2D training positions in the screen spaces of the training cropped images. Training engine 122 may further convert the 2D training positions in the screen spaces of the training cropped images into corresponding 2D training positions in the screen spaces of the corresponding training images.

In step 506, training engine 122 trains the localization model and landmark prediction model using one or more losses computed between the training positions and ground truth landmarks associated with the training images. Continuing with the above example, training engine 122 may compute the loss(es) as a Gaussian negative log likelihood loss, mean squared error, and/or another measure of difference between the 2D training positions and ground truth 2D landmarks for the training images. Training engine 122 may additionally use a training technique (e.g., gradient descent and backpropagation) to iteratively update weights of the localization model and landmark prediction model in a way that reduces the loss(es).

In step 508, execution engine 124 generates, via execution of the trained localization model, a cropped image corresponding to a region within an image that depicts an object. For example, execution engine 124 may use the trained localization model to generate an additional set of body landmarks for a body depicted in the image. Execution engine 124 may also use the body landmarks to localize a face (or another type of body part) within the image, compute a bounding box for the face, and use the bounding box to crop the face from the image.

In step 510, execution engine 124 determines, via execution of the trained landmark prediction model, a set of coefficients and/or positions associated with an object depicted in the image and/or cropped image. For example, execution engine 124 may input the image and/or cropped image (and optional position-encoded points in a canonical space associated with the object) into the trained landmark prediction model. Execution engine 124 may obtain, as corresponding output of the trained landmark prediction model, coefficients of a morphable model, 3D landmarks that include 3D positions of points on the object (e.g., as determined by evaluating the morphable model using the coefficients), and/or 2D landmarks that include 2D positions of the points (e.g., as determined by projecting the 3D positions onto a screen space associated with the image and/or cropped image).

In step 512, execution engine 124 performs a downstream task using the coefficients and/or positions. For example, execution engine 124 may use the generated coefficients, 3D positions, and/or 2D positions to perform shape reconstruction, shape editing, shape retargeting, texture generation, visibility estimation, facial segmentation, landmark tracking, and/or other tasks involving coefficients of morphable models and/or positions of points on objects.

In sum, the disclosed techniques use a set of machine learning models to perform and/or improve various tasks related to landmark detection. One task involves training a landmark prediction model to predict, for a set of points in a canonical 3D space associated with a deformable object (e.g., a face) depicted in an image, a set of coefficients that can be used to evaluate a parametric morphable model at each point. The result of the evaluating the parametric morphable model using the coefficients can be used to determine 3D landmarks that include 3D positions of the points in the same canonical space and/or 2D landmarks that include 2D positions of the points in a screen space associated with the image while using ground truth 2D landmarks associated with the image as supervision.

Another task involves training a localization model to predict body landmarks for a body depicted in the image and using the body landmarks to localize and crop a face (or another body part) from the image. This training can be performed end-to-end with the landmark prediction model, so that the localization model learns to localize objects within images in a manner that is optimized for the downstream landmark detection task performed by the landmark prediction model.

One technical advantage of the disclosed techniques is the ability to predict landmarks as local coefficients of a parametric morphable model. These local coefficients may then be used to perform 3D shape reconstruction, shape editing, performance retargeting, texture completion, visibility estimation, and/or other tasks, thereby reducing latency and resource overhead over prior techniques that generate 2D landmarks and perform additional processing related to the 2D landmarks during downstream tasks. These predicted attributes may additionally result in more stable 2D landmarks than conventional approaches that perform landmark detection only in 2D space. Another technical advantage of the disclosed techniques is the ability to crop an object from an image in a manner that is optimized for a subsequent landmark detection task. These technical advantages provide one or more technological improvements over prior art approaches.
1. In some embodiments, a computer-implemented method for performing landmark detection comprises generating, via execution of a first machine learning model, a first set of morphable model coefficients associated with a first object depicted in a first image; determining one or more three-dimensional (3D) landmarks on the first object based on the first set of morphable model coefficients; projecting the one or more 3D landmarks onto the first image to generate one or more two-dimensional (2D) landmarks; and training the first machine learning model based on one or more losses associated with the one or more 2D landmarks to generate a first trained machine learning model.
2. The computer-implemented method of clause 1, further comprising determining, via execution of a second machine learning model, a first set of parameters used to determine at least one of the one or more 3D landmarks or the one or more 2D landmarks; and training the second machine learning model based on the one or more losses.
3. The computer-implemented method of any of clauses 1-2, wherein the first set of parameters comprises at least one of a head pose or a camera parameter.
4. The computer-implemented method of any of clauses 1-3, further comprising determining, via execution of a second machine learning model, one or more additional 2D landmarks on a second object depicted in a second image; generating the first image from a region within the second image that includes a subset of the one or more additional 2D landmarks corresponding to the first object; and training the second machine learning model based on the one or more losses.
5. The computer-implemented method of any of clauses 1-4, wherein the second object comprises a body and the first object comprises a body part included in the body.
6. The computer-implemented method of any of clauses 1-5, further comprising generating, via execution of the first trained machine learning model, a second set of morphable model coefficients associated with a second object depicted in a second image; and generating a 3D shape associated with the second object based on the second set of morphable model coefficients.
7. The computer-implemented method of any of clauses 1-6, wherein generating the 3D shape comprises at least one of generating an animation associated with the second object based on the 3D shape; applying the second set of morphable model coefficients to a morphable model of a third object; or editing the 3D shape based on the second set of morphable model coefficients.
8. The computer-implemented method of any of clauses 1-7, wherein generating the first set of morphable model coefficients comprises converting one or more points on a canonical shape into one or more position encodings; and generating, via execution of the first machine learning model, the first set of morphable model coefficients based on (i) a set of features associated with the first image and (iii) the one or more position encodings.
9. The computer-implemented method of any of clauses 1-8, wherein the first set of morphable model coefficients comprises at least one coefficient for each point included in the one or more points.
10. The computer-implemented method of any of clauses 1-9, wherein the first object comprises at least one of a face, a body, or a body part.
11. In some embodiments, one or more non-transitory computer-readable media store instructions that, when executed by one or more processors, cause the one or more processors to perform the steps of generating, via execution of a first machine learning model, a first set of morphable model coefficients based on a first image depicting a first object; determining one or more three-dimensional (3D) landmarks on the first object based on the first set of morphable model coefficients; projecting the one or more 3D landmarks onto the first image to generate one or more two-dimensional (2D) landmarks; and training the first machine learning model based on one or more losses associated with the one or more 2D landmarks to generate a first trained machine learning model.
12. The one or more non-transitory computer-readable media of clause 11, wherein the instructions further cause the one or more processors to perform the steps of determining, via execution of a second machine learning model, one or more additional 2D landmarks on a second object depicted in a second image; generating the first image based on a bounding box within the second image that includes a subset of the one or more additional 2D landmarks corresponding to the first object; and training the second machine learning model based on the one or more losses.
13. The one or more non-transitory computer-readable media of any of clauses 11-12, wherein the second object comprises a body and the first object comprises a face on the body.
14. The one or more non-transitory computer-readable media of any of clauses 11-13, wherein determining the one or more 3D landmarks comprises determining, via execution of a second machine learning model, a pose of the first object; and generating the one or more 3D landmarks based on an evaluation of a morphable model using the first set of morphable model coefficients and the pose of the first object.
15. The one or more non-transitory computer-readable media of any of clauses 11-14, wherein the instructions further cause the one or more processors to perform the steps of generating, via execution of the first trained machine learning model, a second set of morphable model coefficients associated with a second object depicted in a second image; and generating a 3D shape associated with a third object based on the second set of morphable model coefficients.
16. The one or more non-transitory computer-readable media of any of clauses 11-15, wherein the second set of morphable model coefficients comprise at least one of an identity coefficient or an expression coefficient.
17. The one or more non-transitory computer-readable media of any of clauses 11-16, wherein generating the first set of morphable model coefficients comprises converting a point on a canonical shape into a position encoding; and generating, via execution of the first machine learning model, at least a portion of the first set of morphable model coefficients based on (i) a set of features associated with the first image and (iii) the position encoding.
18. The one or more non-transitory computer-readable media of any of clauses 11-17, wherein the instructions further cause the one or more processors to perform the step of synthesizing the first image based on at least one of a reconstructed facial geometry, a facial texture associated with the reconstructed facial geometry, an artist-created asset, an environment map, or a set of camera parameters.
19. The one or more non-transitory computer-readable media of any of clauses 11-18, wherein the one or more losses comprise a Gaussian negative likelihood loss.
20. In some embodiments, a system comprises one or more memories that store instructions, and one or more processors that are coupled to the one or more memories and, when executing the instructions, are configured to perform the steps of determining a first machine learning model, wherein the first machine learning model is trained based on one or more losses associated with one or more landmarks corresponding to one or more sets of morphable model coefficients generated by the first machine learning model from a set of training images; generating, via execution of the first machine learning model, a second set of morphable model coefficients associated with an object depicted in an image; and generating a 3D shape associated with the object based on the second set of morphable model coefficients.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing landmark detection, the method comprising:
generating, via execution of a first machine learning model, a first set of morphable model coefficients associated with a first object depicted in a first image;
determining one or more three-dimensional (3D) landmarks on the first object based on the first set of morphable model coefficients;
projecting the one or more 3D landmarks onto the first image to generate one or more two-dimensional (2D) landmarks; and
training the first machine learning model based on one or more losses associated with the one or more 2D landmarks to generate a first trained machine learning model.

2. The computer-implemented method of claim 1, further comprising:
determining, via execution of a second machine learning model, a first set of parameters used to determine at least one of the one or more 3D landmarks or the one or more 2D landmarks; and
training the second machine learning model based on the one or more losses.

3. The computer-implemented method of claim 2, wherein the first set of parameters comprises at least one of a head pose or a camera parameter.

4. The computer-implemented method of claim 1, further comprising:
determining, via execution of a second machine learning model, one or more additional 2D landmarks on a second object depicted in a second image;
generating the first image from a region within the second image that includes a subset of the one or more additional 2D landmarks corresponding to the first object; and
training the second machine learning model based on the one or more losses.

5. The computer-implemented method of claim 4, wherein the second object comprises a body and the first object comprises a body part included in the body.

6. The computer-implemented method of claim 1, further comprising:
generating, via execution of the first trained machine learning model, a second set of morphable model coefficients associated with a second object depicted in a second image; and
generating a 3D shape associated with the second object based on the second set of morphable model coefficients.

7. The computer-implemented method of claim 6, wherein generating the 3D shape comprises at least one of:
generating an animation associated with the second object based on the 3D shape;
applying the second set of morphable model coefficients to a morphable model of a third object; or
editing the 3D shape based on the second set of morphable model coefficients.

8. The computer-implemented method of claim 1, wherein generating the first set of morphable model coefficients comprises:
converting one or more points on a canonical shape into one or more position encodings; and
generating, via execution of the first machine learning model, the first set of morphable model coefficients based on (i) a set of features associated with the first image and (iii) the one or more position encodings.

9. The computer-implemented method of claim 8, wherein the first set of morphable model coefficients comprises at least one coefficient for each point included in the one or more points.

10. The computer-implemented method of claim 1, wherein the first object comprises at least one of a face, a body, or a body part.

11. One or more non-transitory computer-readable media storing instructions that, when executed by one or more processors, cause the one or more processors to perform the steps of:
generating, via execution of a first machine learning model, a first set of morphable model coefficients based on a first image depicting a first object;
determining one or more three-dimensional (3D) landmarks on the first object based on the first set of morphable model coefficients;
projecting the one or more 3D landmarks onto the first image to generate one or more two-dimensional (2D) landmarks; and
training the first machine learning model based on one or more losses associated with the one or more 2D landmarks to generate a first trained machine learning model.

12. The one or more non-transitory computer-readable media of claim 11, wherein the instructions further cause the one or more processors to perform the steps of:
determining, via execution of a second machine learning model, one or more additional 2D landmarks on a second object depicted in a second image;
generating the first image based on a bounding box within the second image that includes a subset of the one or more additional 2D landmarks corresponding to the first object; and
training the second machine learning model based on the one or more losses.

13. The one or more non-transitory computer-readable media of claim 12, wherein the second object comprises a body and the first object comprises a face on the body.

14. The one or more non-transitory computer-readable media of claim 11, wherein determining the one or more 3D landmarks comprises:
determining, via execution of a second machine learning model, a pose of the first object; and
generating the one or more 3D landmarks based on an evaluation of a morphable model using the first set of morphable model coefficients and the pose of the first object.

15. The one or more non-transitory computer-readable media of claim 11, wherein the instructions further cause the one or more processors to perform the steps of:
generating, via execution of the first trained machine learning model, a second set of morphable model coefficients associated with a second object depicted in a second image; and
generating a 3D shape associated with a third object based on the second set of morphable model coefficients.

16. The one or more non-transitory computer-readable media of claim 15, wherein the second set of morphable model coefficients comprise at least one of an identity coefficient or an expression coefficient.

17. The one or more non-transitory computer-readable media of claim 11, wherein generating the first set of morphable model coefficients comprises:
converting a point on a canonical shape into a position encoding; and
generating, via execution of the first machine learning model, at least a portion of the first set of morphable model coefficients based on (i) a set of features associated with the first image and (iii) the position encoding.

18. The one or more non-transitory computer-readable media of claim 11, wherein the instructions further cause the one or more processors to perform the step of synthesizing the first image based on at least one of a reconstructed facial geometry, a facial texture associated with the reconstructed facial geometry, an artist-created asset, an environment map, or a set of camera parameters.

19. The one or more non-transitory computer-readable media of claim 11, wherein the one or more losses comprise a Gaussian negative likelihood loss.

20. A system, comprising:
one or more memories that store instructions, and
one or more processors that are coupled to the one or more memories and, when executing the instructions, are configured to perform the steps of:
determining a first machine learning model, wherein the first machine learning model is trained based on one or more losses associated with one or more landmarks corresponding to one or more sets of morphable model coefficients generated by the first machine learning model from a set of training images;
generating, via execution of the first machine learning model, a second set of morphable model coefficients associated with an object depicted in an image; and
generating a 3D shape associated with the object based on the second set of morphable model coefficients.
